(19) United States
(12) Patent Application Publication
(10) Pub. No.: US 2013/0211591 A1
(43) Pub. Date: Aug. 15, 2013

(54) AUTONOMOUS ROBOT AND METHOD OF CONTROLLING THE SAME

(71) Applicants: Young Ho SUH, Gwangju (KR); Hyun Kim, Daejeon (KR)

(72) Inventors: Young Ho SUH, Gwangju (KR); Hyun Kim, Daejeon (KR)

(73) Assignee: ELECTRONICS AND TELECOMMUNICATIONS RESEARCH INSTITUTE, Daejeon (KR)

(21) Appl. No.: 13/586,460

(22) Filed: Aug. 15, 2012

(30) Foreign Application Priority Data
Feb. 14, 2012 (KR) 10-2012-0014980

(51) Int. Cl. B25J 13/08

(52) U.S. Cl. 700/258; 901/9

(57) ABSTRACT

Disclosed are a robot and a method of controlling the robot, and more particularly are an autonomous robot and a method of controlling the autonomous robot. The autonomous robot includes a sensor for detecting a change of a situation; an actuator; and a controller for controlling the actuator based on information input through the sensor, wherein the controller controls the actuator in accordance with mode information including an act abstraction layer which defines a unit act by combining functions of the sensor and the actuator.

### CROSS-REFERENCE TO RELATED APPLICATIONS

This application claims priority to and the benefit of Korean Patent Application No. 10-2012-0014980 filed in the Korean Intellectual Property Office on Feb. 14, 2012, the entire contents of which are incorporated herein by reference.

### TECHNICAL FIELD

The present invention relates to a robot and a method of controlling the robot, and more particularly, to an autonomous robot and a method of controlling the autonomous robot.

### BACKGROUND ART

Recently, various types of intelligent robots have been developed. A personal service robot among the intelligent robots means a robot providing a user with services by using a function of a robot in an environment, such as at home or at work. Some service robots, such as a cleaning robot and an educational robot, have been presently released and used, but a meaningful market has not been established yet.

As such, the most significant reason that a large market of personal service robots has not been established yet is that there is no killer application or a quality of provided services (cleaning, education, etc.) is not satisfied.

However, another reason, which is equally as significant as the other reasons, is that users easily grow tired of the service robots. That is, while users are satisfied with the proper performance of the functions of general home appliances, with robots, they hope to find satisfaction in continuous interaction between the user and the robot in addition to the robot's main service (cleaning, education, etc.)

Accordingly, a robot providing only the same service does not retain interest for a user. In this respect, a consideration of a system for maintaining a “relation” through continuous interaction between a user and a service robot is required.

### SUMMARY OF THE INVENTION

The present invention has been made in an effort to provide a robot capable of autonomously acting depending on a situation even if there is no request from a user, as well as providing a service according to an explicit request of a user.

An exemplary embodiment of the present invention provides an autonomous robot including: a sensor for detecting a change of a situation; an actuator; and a controller for controlling the actuator based on information input through the sensor, wherein the controller controls the actuator in accordance with mode information including an act abstraction layer which defines a unit act by combining functions of the sensor and the actuator.

Another exemplary embodiment of the present invention provides a method of controlling an autonomous robot including a sensor for detecting a change of a situation and an actuator, the method including: receiving input of a detected change from the sensor; determining a situation based on the detected change; and controlling the actuator in accordance with mode information including an act abstraction layer which defines a unit act by combining functions of the sensor and the actuator according to the determined situation.

According to the invention disclosed herein, the robot is able to perform an autonomous act depending on a situation even if there is no request from a user, as well as to provide a service according to an explicit request of a user, so that it is possible to achieve continuous interaction between the user and the service robot.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a device abstraction layer and an act abstraction layer for controlling an autonomous robot.

FIG. 2 is a diagram illustrating execution of a unit act in detail.

FIGS. 3A to 3C are diagrams illustrating a combination relation between unit acts for accomplishing a predetermined goal.

FIG. 4 is a diagram illustrating an autonomous robot disclosed in the present specification in detail.

FIG. 5 is a diagram illustrating a method of controlling an autonomous robot disclosed in the present specification in detail.

FIG. 6 is a diagram illustrating a tree structure of layers for a system control of an autonomous robot in detail.

FIG. 7 is a diagram illustrating a structure of the system control described in FIG. 6 in detail.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description merely illustrates principles of the present invention. Therefore, although not clearly described and illustrated in this specification, those skilled in the art can implement the principles of the present invention and invent various apparatuses included in the concept and range of the present invention. Further, all of the conditional terms and embodiments stated in this specification are obviously intended only for the purpose of making the concept of the present invention understood in principle, and the present invention should be construed to be not limited to the stated embodiments and states in particular.

Further, all statements herein reciting principles, aspects, and embodiments of the invention, as well as specific examples thereof, are intended to encompass both structural and functional equivalents thereof. Additionally, it is intended that such equivalents include currently known equivalents as well as equivalents developed in the future, i.e., any elements developed that perform the same function, regardless of the structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudo code, and the like represent various processes which may be substantially represented in a computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

Moreover, explicit use of the term “processor” or “controller”, or the term provided as a similar concept to the term should not be construed to refer exclusively to hardware capable of executing software, and may include, without limitation, digital signal processor (DSP) hardware, read only memory (ROM) for storing software, random access memory (RAM), and non-volatile storage.

In the claims of the present invention, elements represented as means for performing a function described in the detailed description are intended to include, for example, all methods for performing functions including all types of software including combinations of circuit devices performing functions or firmware/micro code and the like, and they are combined with appropriate circuits to implement the software to perform the functions. Since the present invention defined by such claims is combined with functions supplied by the means variously explained and combined with methods required by the claims, it should be understood that any means capable of supplying the functions are equivalent to those understood from the present specification.

The above and other aspects, features, and advantages of the present invention will be more apparent from the following detailed description taken in conjunction with the accompanying drawings, and accordingly those skilled in the art can easily implement the technical idea of the present invention. Further, a detailed description of known functions and configurations incorporated herein will be omitted when it may make the subject matter of the present invention rather unclear. Hereinafter, exemplary embodiments according to the present invention will be described in detail with reference to the accompanying drawings.

An autonomous robot and a method of controlling the autonomous robot are disclosed in the present specification. The autonomous robot disclosed in the present specification is able to perform an autonomous act depending on a situation even if there is no request from a user, as well as provide a service according to an explicit request of a user, so that it is possible to achieve continuous interaction between a user and a service robot.

In order to maintain a “relation” with the user through continuous interaction, the following functions are required to be considered for a robot control structure and system.

The first function to consider is to expand necessary acts by providing an act layer in which sensors and an actuator device provided by a robot are abstracted and combining functions of the sensors and the actuator.

The second function to consider is to expand an autonomous act of a robot for accomplishing a goal according to each situation by combining and planning unit acts.

The third function to consider is to make a robot autonomously act by defining a goal of an act of a robot with respect to an interested situation and each situation, and executing and coordinating robot act plans according to a situation during an actual operation.

The present specification suggests an autonomous robot capable of autonomously acting in accordance with an act plan corresponding to a situation even without an explicit request of a user and a method of controlling the autonomous robot. To this end, unit acts, which the robot may perform, may be easily expanded, a robot motion for a necessary autonomous act may be planned by combining predefined acts, and the autonomous acts may be executed and coordinated according to a situation.

Hereinafter, the autonomous robot and the method of controlling the autonomous robot will be described with reference to the drawings in detail.

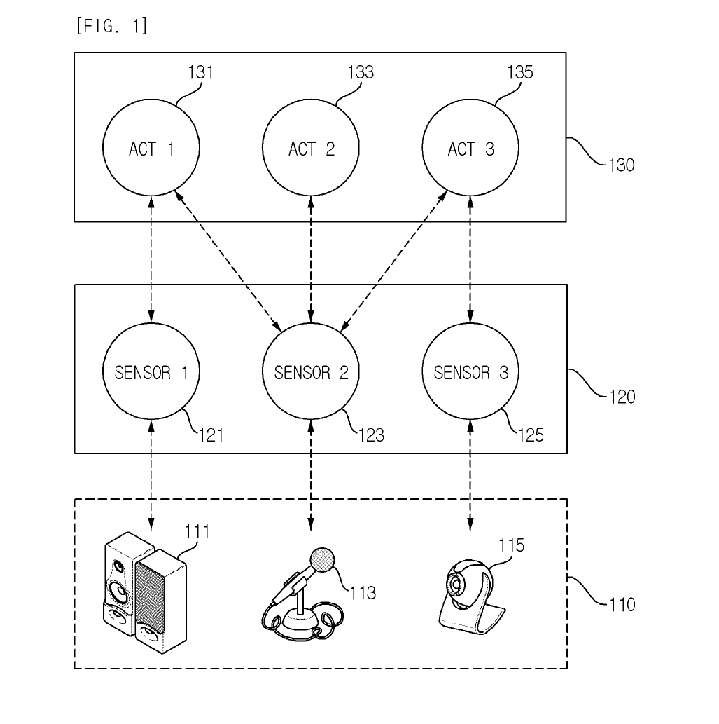

FIG. 1 is a diagram illustrating a device abstraction layer and an act abstraction layer for controlling the autonomous robot.

Referring to FIG. 1, a device abstraction layer 120 (121, 123, and 125) defines functions for sensor 1 121, sensor 2 123, and sensor 3 125, and physical devices 111, 113, and 115, such as an actuator, provided by the autonomous robot. An act abstraction layer 130 (131, 133, and 135) defines unit acts, act 1 131, act 2 133, and act 3 135 provided by the autonomous robot by combining the functions of the sensors or the actuators provided by the device abstraction layer 120. The unit acts 131, 133, and 135 of the act abstraction layer 130 may be continuously expanded through combination with the functions of the sensor 1 121, the sensor 2 123, and the sensor 3 125 in the device abstraction layer 120 and/or the unit acts, the act 1 131, the act 2 133, and the act 3 135, in the act abstraction layer 130. The device abstraction layer 120 may be positioned under the act abstraction layer 130 according to a layer structure.

For example, a unit act (LookAtSound: an act of looking at in a direction in which sound is generated by controlling a motor) of the act abstraction layer may be defined by combining functions of a sound recognition sensor (sound localizer) and a motor controller of the device abstraction layer.

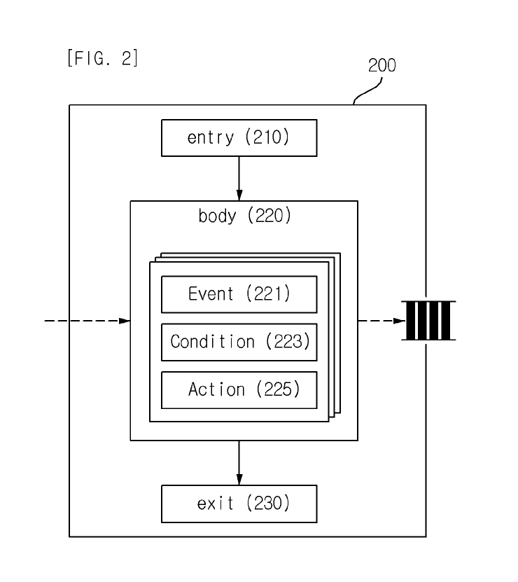

FIG. 2 is a diagram illustrating execution of a unit act in detail.

Referring to FIG. 2, when the unit act 200 is started, an entry( ) function 210 may be once called, and when the unit act 200 is completed, an exit( ) function 230 may be once called, and the unit act 200 may be operated based on an Event-Condition-Action (ECA) rule in a space (body) 220 between the start and the end. The ECA rule is to provide a pre-described action 225 or service based on a condition 223 of a situation at the time of the generation of an event 221.

The event 221 is transferred from the sensor existing in a lower device abstraction layer and the action 225 is revealed through the actuator. One unit act may include a plurality of ECA rules.

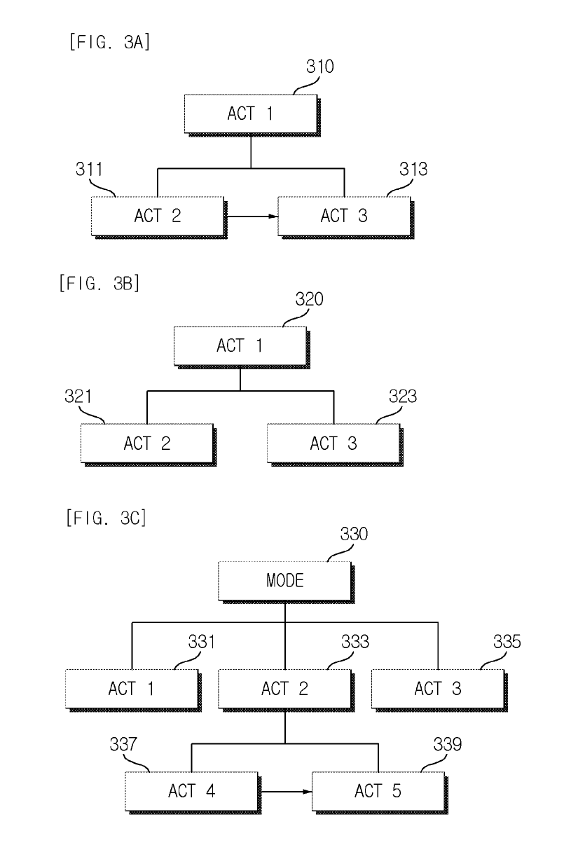

FIGS. 3A to 3C are diagrams illustrating a combination relation between unit acts for accomplishing a predetermined goal. The unit acts may be combined or planned as a complex act in order to accomplish a goal according to a situation. Every act may include one or more child acts in its lower layer according to the layer structure.

Referring to FIGS. 3A to 3C, FIG. 3A illustrates a structure in which act 1 310 is constructed by sequential performance of act 2 311 and act 3 313, and FIG. 3B illustrates a structure in which act 1 320 is constructed by concurrent performance of act 2 321 and act 3 323. The entry( ) function of the act generates child acts, and a scheme of the performance may be designated as one between the sequential performance method and the concurrent performance method. The sequential performance means that a next act is performed after the performance of a previous act is completed, and the concurrent performance means that all acts are simultaneously performed. The sequential performance/concurrent performance is an example of a time series condition for the child acts included in the act, and various forms of time conditions may be generated.

FIG. 3C illustrates complex acts in a tree structure. In the tree structure, the sequential performance and the concurrent performance are combined, and acts 1 to 3 331, 333, and 335 correspond to the concurrent performance and acts 4 337 and act 5 339 correspond to the sequential performance. The highest act corresponds to a mode (goal) 330 and a single mode may be defined for each necessary situation. A flow of the control may progress from a higher act to a lower act and a flow of the event may progress from a lower act to a higher act.

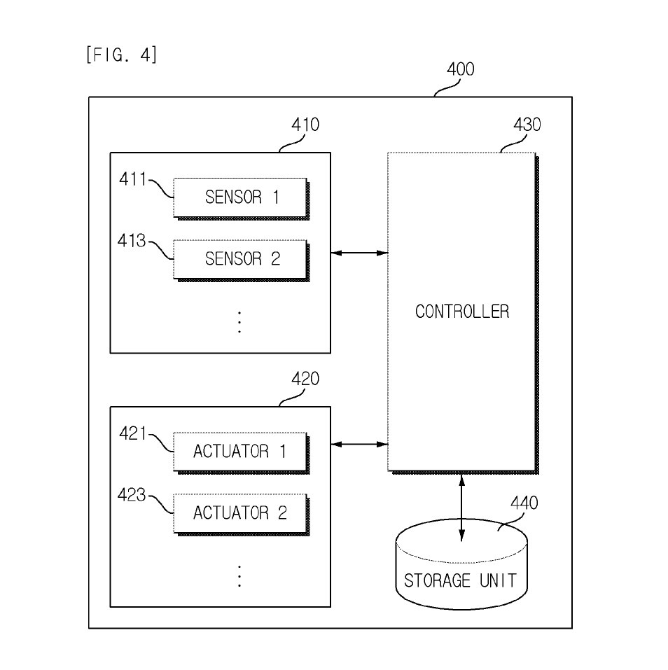

FIG. 4 is a diagram illustrating an autonomous robot disclosed in the present specification in detail.

Referring to FIG. 4, the autonomous robot 400 includes a sensor 410, an actuator 420, and a controller 430.

The sensor 410 detects a change of an outside situation. The change of the situation may include all detectable changes, such as a change of light, sound, and temperature. A change of movement may be included in the change of the situation, and a change of a motion through an analysis of an image obtained by a camera may be detected. A plurality of sensors 411 and 413 may be mounted on the autonomous robot.

In the meantime, the sensor 410 of the autonomous robot 400 may utilize an external sensor. That is, the sensor 410 of the autonomous robot 400 includes a form of wireless or wired reception of relevant information from an external sensor which is not mounted on the autonomous robot 400. Accordingly, a wireless or wired receiver 410 receiving the relevant information from the external sensor in this case may be interpreted as the sensor of the autonomous robot.

The actuator 420 means a machine device used for moving or controlling the system and is used as a generic term of a driving device using electricity, oil pressure, compressed air, or the like. A plurality of actuators 421 and 423 may be mounted on the autonomous robot 400.

The controller 430 controls the actuator 420 based on information input through the sensor 410. The controller 430 controls the actuator 420 in accordance with mode information including the act abstraction layer which defines the unit act by combining the functions of the sensor 410 and the actuator 420. Here, the mode information may mean a goal of an act for each necessary situation, and one piece of mode information may be defined for each situation.

The mode information may further include the device abstraction layer which defines a unit function of the sensor 410 and the actuator 420.

The unit act may be defined in accordance with the ECA rule which controls the actuator 420 according to a situation based on the information input through the sensor 410, and the unit act may include a plurality of ECA rules.

The act abstraction layer may include the tree structure in which the unit acts are combined and may include information about a time series order of the unit acts.

The mode information may be defined according to a necessary situation, and the number of pieces of mode information may be two or more depending on the definition.

In the meantime, the controller 430 may transit or coordinate the mode information based on coordinator information according to a situation. The coordinator information is used for transiting or coordinating a mode appropriate to a corresponding situation when there is a plurality of modes, and may be positioned in the highest layer which controls all of the mode information. The coordinator information may be defined in accordance with the ECA rule.

The information on a control structure for controlling the autonomous robot by the controller 430 may be stored in a separate storage unit 440. In the meantime, the control structure may also be defined according to a preset structure, and may be automatically expanded according to learning of the autonomous robot 400.

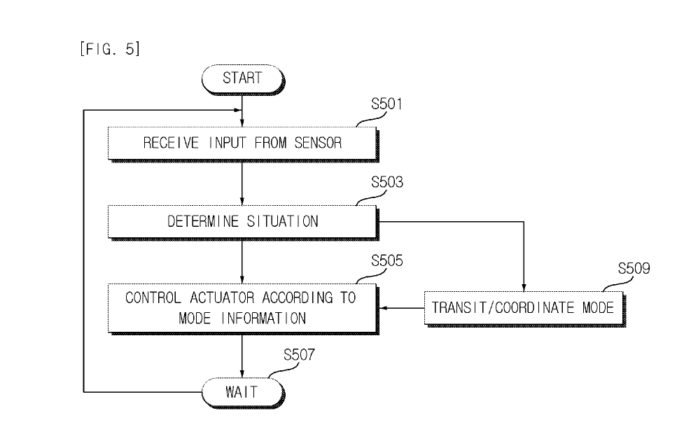

FIG. 5 is a diagram illustrating a method of controlling an autonomous robot disclosed in the present specification in detail.

Referring to FIG. 5, the method of controlling the autonomous robot including the sensor detecting a change of a situation and the actuator includes step S501 of receiving an input of a detected change from the sensor, step S503 of determining a situation based on the detected change, and step S505 of controlling the actuator in accordance with mode information including the act abstraction layer which defines a unit act by combining functions of the sensor and the actuator according to the determined situation.

The mode information may further include the device abstraction layer defining a unit function of the sensor and the actuator, and the unit act may be defined in accordance with the ECA rule which controls the actuator based on the information input through the sensor according to a situation. Here, the unit act may include a plurality of ECA rules.

The act abstraction layer may include a tree structure in which the unit acts are combined and may include information about a time series order of the unit act.

When step S505 of controlling the actuator is completed, it is switched to a standby state in step S507 and returns to step S501 of receiving an input from the sensor.

The mode information may be defined according to a situation, and the number of pieces of the mode information may be two or more. Here, step S505 of controlling the actuator may further include step S509 of transiting or coordinating the mode information based on coordinator information according to the situation. The coordinator information may be defined in accordance with the ECA rule.

Other detailed descriptions about the autonomous robot have been given in the description of FIGS. 1 to 4, so they will be omitted herein.

Hereinafter, an exemplary embodiment of the invention disclosed in the present specification will be described with reference to the drawing in detail.

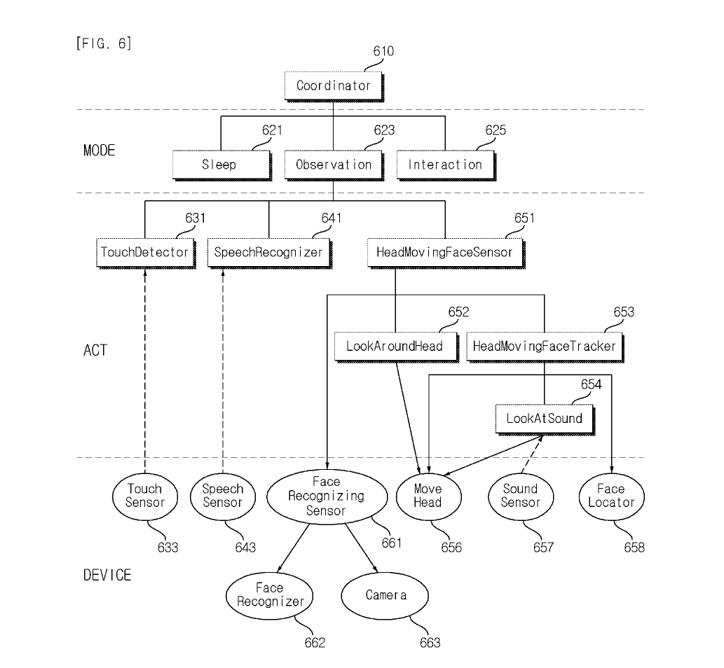

FIG. 6 is a diagram illustrating a tree structure of layers for a system control of an autonomous robot in detail.

Referring to FIG. 6, a coordinator 610 is positioned in the highest layer. A single mode exists for each necessary situation, and an act tree having the single mode as the highest parent is constructed. For example, three modes, sleep 621, observation 623, and interaction 625, are defined, and in a case of the observation mode 623, an act tree is defined as illustrated in FIG. 6. As such, the coordinator 610, which transits and coordinates a mode to be appropriate to a situation when there exist the plurality of modes 621, 623, and 625, is positioned at the top.

For example, touch and speech are detected 631 and recognized 641 according to a touch sensor 633 and a speech sensor 643, and an act 651 of moving along a face of a user is performed. The act 651 of moving along the face of the user includes a plurality of child acts 652, 653, and 654. The act 651 of moving along the face of the user is constructed with the child acts of an act 652 of turning a head of the autonomous robot and an act 653 of tracing the face of the user. To this end, sensors 661, 662, and 663 for recognizing the face of the user are driven. In this case, actuators 656 and 658 for performing the act of moving the head of the autonomous robot are driven. When a sound sensor 657 recognizes sound, an act 654 of turning the head of the autonomous robot in a direction in which the sound is generated is performed.

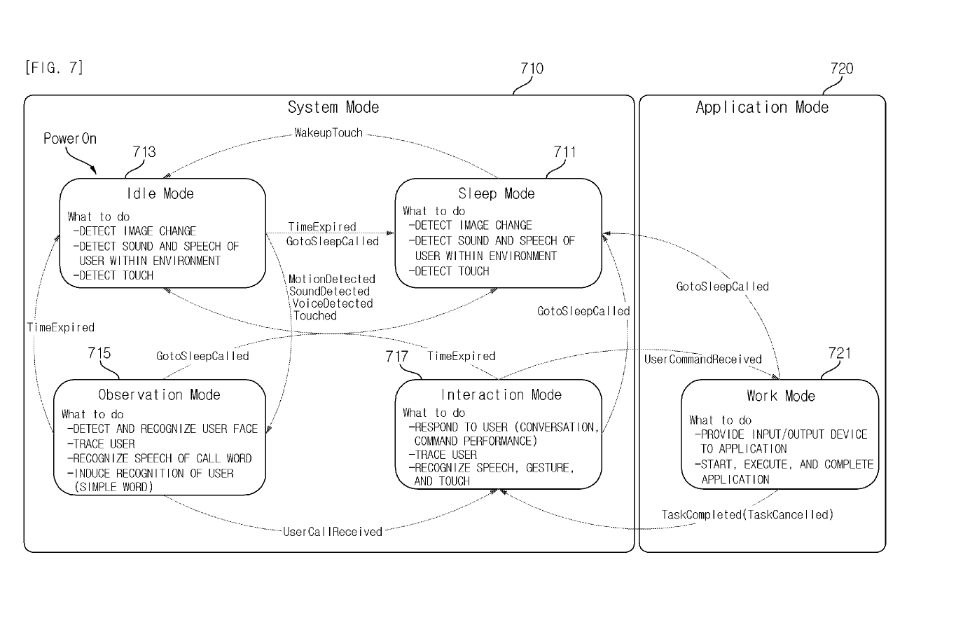

FIG. 7 is a diagram illustrating a structure of the system control described in FIG. 6 in detail.

Referring to FIG. 7, the entire system control generally includes an application mode 720 performing a service according to an explicit request of a user and a system mode 710 performing an autonomous act even through there is no request of the user.

The application mode 720, which performs a specific command (cleaning, education, etc.) of the user, corresponds to a work mode 721. When a specific command is completed, the application mode 720 returns to the system mode 710.
Work mode 721: Situation in which a service is provided according to an explicit work request of a user.

The system mode 710 means a state in which there is no specific command of the user, and includes a sleep mode 711, an idle mode 713, an observation mode 715, and an interaction mode 717.
Sleep mode 711: Situation in which there occurs no change of an outside environment for a long time.
Idle mode 713: Situation of detecting sound or an image while looking around in order to detect a change of sound or an image within an environment.
Observation mode 715: Situation of observing contents (user/object) of a change by detecting a change of sound or an image within an environment.
Interaction mode 717: Situation of performing interaction with a user according to recognition of the user.

The sleep mode 711 is a mode in which the system is started when touch or sound (including speech) is detected, and when the system is started, the sleep mode 711 is transited to the idle mode 713. When another peculiar situation is not detected during a predetermined time, the idle mode 713 is transited to the sleep mode 711 again.

The idle mode 713 is a mode of detecting sound and speech of a user within an environment or recognizing touch, and detecting a change of an image input by a camera, etc. The observation mode 715 is a mode of detecting and recognizing a face of the user, tracing the user, and inducing recognition of the user. In the observation mode 715, simple conversation with the user may be performed in order to induce the recognition of the user. The interaction mode 717 is a mode of performing concrete interaction with the user according to the recognition of the user. The interaction mode 717 traces the user and responds to the user, so that when an explicit command of the user is input, the mode is transited such that the command may be processed in a work mode 721 of the application mode 720.

The aforementioned five modes may be transited and/or coordinated by the mode coordinator, and the mode coordinator may process the transition/coordination between respective modes in accordance with the ECA rule.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An autonomous robot comprising:
a sensor for detecting a change of a situation;
an actuator; and
a controller for controlling the actuator based on information input through the sensor,
wherein the controller controls the actuator in accordance with mode information including an act abstraction layer which defines a unit act by combining functions of the sensor and the actuator.

2. The autonomous robot of claim 1, wherein the mode information further includes a device abstraction layer which defines a unit function of the sensor and the actuator.

3. The autonomous robot of claim 1, wherein the unit act is defined in accordance with an Event-Condition-Action (ECA) rule which controls the actuator according to the situation based on the information input through the sensor.

4. The autonomous robot of claim 2, wherein the unit act includes a plurality of ECA rules.

5. The autonomous robot of claim 1, wherein the act abstraction layer includes a tree structure in which the unit acts are combined.

6. The autonomous robot of claim 1, wherein the act abstraction layer includes information about a time series order of the unit act.

7. The autonomous robot of claim 1, wherein the mode information is defined according to the situation.

8. The autonomous robot of claim 1, wherein a number of pieces of the mode information is two or more.

9. The autonomous robot of claim 8, wherein the controller transits or coordinates the mode information based on coordinator information according to the situation.

10. The autonomous robot of claim 9, wherein the coordinator information is defined in accordance with an ECA rule.

11. A method of controlling an autonomous robot comprising a sensor for detecting a change of a situation and an actuator, the method comprising:
receiving input of a detected change from the sensor;
determining a situation based on the detected change; and
controlling the actuator in accordance with mode information including an act abstraction layer which defines a unit act by combining functions of the sensor and the actuator according to the determined situation.

12. The method of claim 11, wherein the mode information further includes a device abstraction layer which defines a unit function of the sensor and the actuator.

13. The method of claim 11, wherein the unit act is defined in accordance with an Event-Condition-Action (ECA) rule which controls the actuator according to the situation based on the information input through the sensor.

14. The method of claim 12, wherein the unit act includes a plurality of ECA rules.

15. The method of claim 11, wherein the act abstraction layer includes a tree structure in which the unit acts are combined.

16. The method of claim 11, wherein the act abstraction layer includes information on a time series order of the unit act.

17. The method of claim 11, wherein the mode information is defined according to the situation.

18. The method of claim 11, wherein a number of pieces of the mode information is two or more.

19. The method of claim 18, wherein the controlling of the actuator further comprises transiting or coordinating the mode information based on coordinator information according to the situation.

20. The method of claim 19, wherein the coordinator information is defined in accordance with an ECA rule.
